(19) United States
(12) Patent Application Publication
(10) Pub. No.: US 2014/0032376 A1
(43) Pub. Date: Jan. 30, 2014

(54) METHOD AND SYSTEM FOR FACILITATING ELECTRONIC COMMERCE

(71) Applicant: Vic Tyagi, Montgomery, IL (US)

(72) Inventor: Vic Tyagi, Montgomery, IL (US)

(21) Appl. No.: 13/983,506

(22) PCT Filed: Jan. 24, 2012
(86) PCT No.: PCT/US12/22358

§ 371 Date: Oct. 15, 2013

Related U.S. Application Data
(60) Provisional application No. 61/439,566, filed on Feb. 4, 2011.

(51) Int. Cl. G06Q 30/06

(52) U.S. Cl. CPC G06Q 30/0641
USPC 705/27.1

(57) ABSTRACT

A system and method for selling or purchasing a product or service via the Internet by providing and connecting a server to the Internet and creating one or more databases on the server with which one or more users may register with, wherein products and services offered for sale or requested for purchase are stored and organized in the server, and are sold and purchased through one or more purchase groups created in the one or more databases.

### RELATED APPLICATIONS

This application claims priority to U.S. Provisional Application No. 61/439,566 filed on Feb. 4, 2011, the entirety of which is incorporated herein by reference.

### FIELD OF THE INVENTION

This invention relates to the field of electronic commerce and more particularly to a system and method of selling and purchasing products and services through a social media based electronic commerce system.

### BACKGROUND

Social media networks are very popular and present new opportunities for the creation of technology to utilize them in numerous ways. Many applications are being developed that leverage these existing networks for electronic commerce. Although these transaction models seem promising, the developers of the applications that exclusively use existing social networks lack full access and control over these networks' users. This lack of control places the developer's future in the hands of these social media networks. The unique model presented in this invention creates an independent website which links to users in existing social media networks that allows these users to sell and purchase products and services in commerce via the World Wide Web.

### SUMMARY OF INVENTION

A system and method of selling a purchasing products and services through a social media based electronic commerce system which may be implemented as a free or fee-based Service by a Service Provider is disclosed. According to one aspect of the invention, the system includes a web server that is communicatively coupled with users, other servers, forums, bulletin boards, or other web servers through the World Wide Web. The Server allows a first user to create a purchase group for selling or requesting a purchasable item, like for example a product or service. Invitations to join the purchase group may be sent from the first user to the other users through the first users' social network contacts; from users who have joined the purchase group to other users through their social network contacts; by the Server through the contacts registered with the Server's databases; or, from other third party servers, forums, and bulletin boards that have a plug-in Application Programming Interface (API) Module installed which communicates to the Server. The first user may also generate interest in an offered purchasable item through advertising, emails, customer contacts, or other means that generate awareness of the item. In order to facilitate sales and enhance the usability of the system, users may indicate an interest in categories of products or services by filling out a survey when registering with the Service. Other third party servers may indicate such preferences by specifying them via the API Module.

The first user may be a manufacturer or provider of the purchasable item, the end user of the purchasable item, or a third party. The item may be a good, such as a flute, or it may be a service, such as custom kitchen remodeling. According to one aspect of the invention, the product or service listed for sale on the server may require that certain parameters set by the first user be met before the purchasable item will become active and be sold to the purchasing users. For example, the first user may require a threshold number of sales before the product or service becomes active and may require the threshold number of sales be reached within a specified time limit.

Examples of purchasable items that may be listed include a special paint color for a Harley Davidson motorcycle, or it may be a custom designed exhaust system for a sports car, a limited edition DVD, tickets for a game/movie/concert/show, training or courses, travel tickets to a destination, or hotel reservations. Some products and services may be discounted from their actual retail or wholesale price to users, while some products and services may be new and previously unoffered. The amount of discount or cost of the product or service may be variable based on the numbers of users who agree to purchase the purchasable item.

According to another aspect of the invention, once a group is created to sell or request a purchasable item, any registered user who fits within any purchase group parameters set by the first user may agree to join the purchase group and purchase the product or service. Together, the users who agree to purchase the purchasable item may be collectively called a purchase group. In order to sell any purchasable item, the first user may provide detailed information related to the uniqueness of the item, the purchase price of the item, a picture of the item, the discount available to the purchase group, the rating of the first user who listed the purchasable item, the manufacturer of the product, the number of users required for the item, the time remaining for the item, or any other factors which might describe the product or service and influence a user to purchase the same.

According to another aspect of the invention, the purchasable item may have associated with it certain parameters that need to be met in order for the purchasable item to become active. Some of these parameters may include the number of users required for a purchasable group for the product or service or the time remaining for an users to join the purchase group. Once any of these parameters have been met for the item, the item will be considered active. Once active, the users who were members of the purchase group for the product or service will be contractually obligated to participate in the group purchase. For purchasable items that do not attain the active state, users may be notified and refunded accordingly.

According to another aspect of the invention, after the purchasable item has become active, it will be up to the first user to ensure that the purchase group properly receives the product or service. This function may be directly handled by the user who listed the product or service or it may be outsourced to other individuals, manufacturers or entities. For example, if the purchasable item is an order for a product, the user who listed the purchasable item may contact the product manufacturer with the bulk-order. Or, in another example, if the purchasable item is a service, the user who listed the purchasable item may contact the service provider to commence service for the purchase group.

The proper conclusion of the purchasable item transaction may be when all services have been rendered for the members of the purchase group, or all items have been received by members of the purchase group. As a means to ensure that users who list purchasable items are fairly judged, users with the purchase group may provide feedback to the Server and databases. This feedback may be in the form of ranking system(s) (i.e. 1 to 5), and/or it may be in the form of personal comments about the users' experiences with the purchasable item; such as the quality, shipping, return time on the product or service, etc.

According to one aspect of the invention, the Service may host or be linked to an electronic payment system. The payment system may accept debit cards, credit cards, checks, wire transfers, or other forms of payment from users of the Service. Users who agree to purchase a purchasable item and thereby become members of a purchase group may be required to make a full or partial payment at the time of joining the group. Payments made by purchase group members may be placed in an escrow account that may not be accessible to the user who listed the purchasable item until that purchasable item becomes active. Once active, the payments received from the purchase group may be ‘pooled’ or aggregated and made available to either the user who listed the purchasable item, or may be directly transferred to the manufacturer of the purchasable item or in the case of a service, directly transferred to the provider of the service. All purchase group members may be notified when a purchasable item becomes active, and when payments have been transferred to the user who listed the purchasable item, manufacturer of the purchasable item, or service provider of the purchasable item.

The Service may also include an Application Programming Interface (API) that allows a third party company which operates a server or website for online forums, bulletin boards, online discussion sites, message boards, or any site where users congregate, to download, install and configure Module or Modules that integrate with the third party server and communicatively couple with the Service over the World Wide Web. By using the API Module, all or some of the features of the Service may be extended to the third party server or website. The server or website may include forums or message boards, like for example automotive, healthcare, construction, general purpose, video games, educational, vocational or trade related, or sports talk or discussion. For the third party server, the API Module may create a forum like for example “LetsPool—Group Buys.” The API Module may also create a sub-forum for product or service categories as configured by the server or website operator on the third party server. Within each sub-forum, the API Module may create topics listing items that are created by a first user. The first user may create a purchase group either from the third party server or website via the API Module, or by linking directly to the Service.

The present invention is provided to solve these and other issues.

### BRIEF DESCRIPTION OF THE FIGURES

FIG. 1 shows details of the Service Provider model with the appropriate software modules.

FIG. 2 shows a model for a database information stored purchasable items.

FIG. 3 shows a user registration model.

FIG. 4 shows a user profile creation model.

FIG. 5 shows a user transaction process model.

FIG. 6 shows a user creation of a purchasable item model.

FIG. 7 shows a model for search and join for a purchasable item group.

FIG. 8 shows more detail on the web access model along with the Service Provider's payment gateway connectivity model.

FIG. 9 shows a model for the overall system and integration of an Application Programming Interface (API).

### DETAILED DESCRIPTION

While the present invention is susceptible of embodiment in many different forms, there is shown in the drawings and will herein be described in detail preferred embodiments of the invention with the understanding that the present disclosure is to be considered as exemplification of the principles of the invention and is not intended to limit the broad aspects of the invention to the embodiments illustrated.

One embodiment of the present invention is directed to a system and method for selling or purchasing a product or service via the World Wide Web utilizing a social media based electronic commerce system. In order to carry out the method, a server having one or more databases created and stored thereon is provided and connected to the Internet. Once the server is connected to the Internet, one or more users may access and register with the databases through the Internet. The one or more databases may be configured to store and organize user information and profiles, and to receive, gather, organize, and store purchasable items, i.e. products or services, listed for sale or requested for purchase by one or more registered users. In order to request a purchasable item or offer a purchasable item for sale, one or more registered users may create a group in the one or more databases to offer or request a purchasable item to or from other registered users.

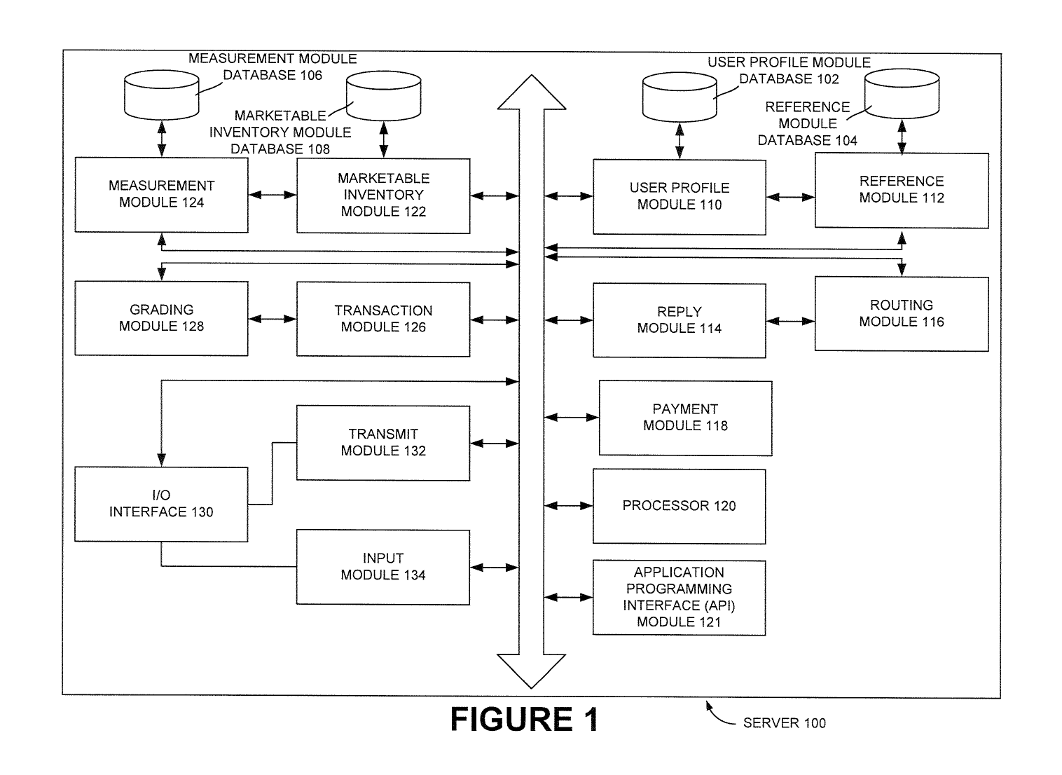

FIG. 1 shows an exemplary embodiment of a Server 100 for use in the system contemplated by the invention. The Server 100 may be configured to include multiple databases, shown in FIG. 1 as a User Profile Module Database 102 working in conjunction with a Reference Module Database 104, and a Measurement Module Database 106 working in conjunction with a Marketable Inventory Module Database 108.

The User Profile Module Database 102 includes a User Profile Module 110 in communication with a Reference Module 112 in the Reference Module Database 104. The combination of the User Profile Module 110 and Reference Module 112 allows users to register with the system and stores and organizes registered user login and profile information to facilitate transactions within the system. The User Profile Module Database 102 may also include a Reply Module 114 in communication with a Routing Module 116 for communication between the databases and the registered user. User Profile Module Database 102 may also include a Payment Module 118 and Processor 120 for facilitating, tracking, and storing user transactions, and an Application Programming Interface (API) Module 121 for allowing third party websites to plug-in and communicate with the system via the World Wide Web.

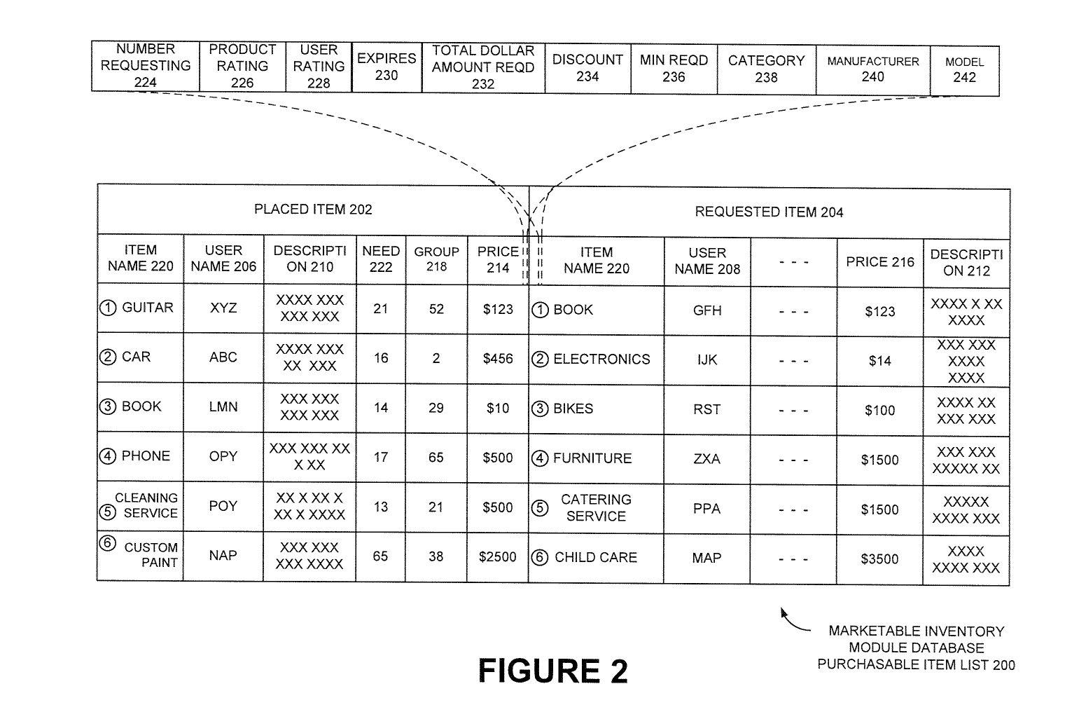

Marketable Inventory Module Database 108 includes a Market Inventory Module 122 in communication with a Measurement Module 124 in the Measurement Module Database 106 for storing, organizing, tracking, and searching various purchasable items offered for sale or requested for purchase by registered users. An example of the information stored in Market Inventory Module 124 is shown in FIG. 2.

As seen in FIG. 2, the Market Inventory Module 122 may include a list or lists 200 which contain numerous columns containing, for example, products and/or services offered for sale 202 or requested for purchase 204; the name of the user offering 206 or requesting 208 the product or service; a description of the product or service offered 210 or requested 212; the price the product or service is offered for 214 or requested at 216; the number of users agreeing to purchase the offered product or service 218; the name of the product or service offered or requested 220; and, the number of users required to agree to purchase the product or service before it becomes active and must be sold or provided 222. Any list or lists stored in Market Inventory Module 122 may further include information such as the number of users requesting 224 a product or service, a review or rating 226 of the product if previously offered in the database, a review or rating of the seller 228 of the product or service, the time limit or date 230 by which users have to agree to purchase the product or service, a total aggregate dollar amount for sales 232 of any products or services offered by a user, information related to further discounts 234 for the product or service as additional users join group to purchase the offered product or service, any parameters for the group 236 which must be met before the product or service will become active and be sold to the purchasing users, a category 238 for the product or service, the manufacturer of the product or provider 240 of the service if different from the user offering the product or service, and a description of the product or products 242 used to complete the service. Market Inventory Module Database 108 and Measurement Module Database 106 may track and store any information entered by a user associated with any offered or requested product or service.

As seen in FIG. 1, the Market Inventory Module Database 108 may further include a Transaction Module 126 in communication with a Grading Module 128 in the Measurement Module Database 106 for facilitating transactions and tracking reviews of users and the products and services offered for sale. Finally, the Market Module Database 108 and Measurement Module Database 106 may further include an I/O Interface 130, a Transmit Module 132, and an Input Module 134 for listing products or services in the database and further facilitating and completing transactions with purchasing users.

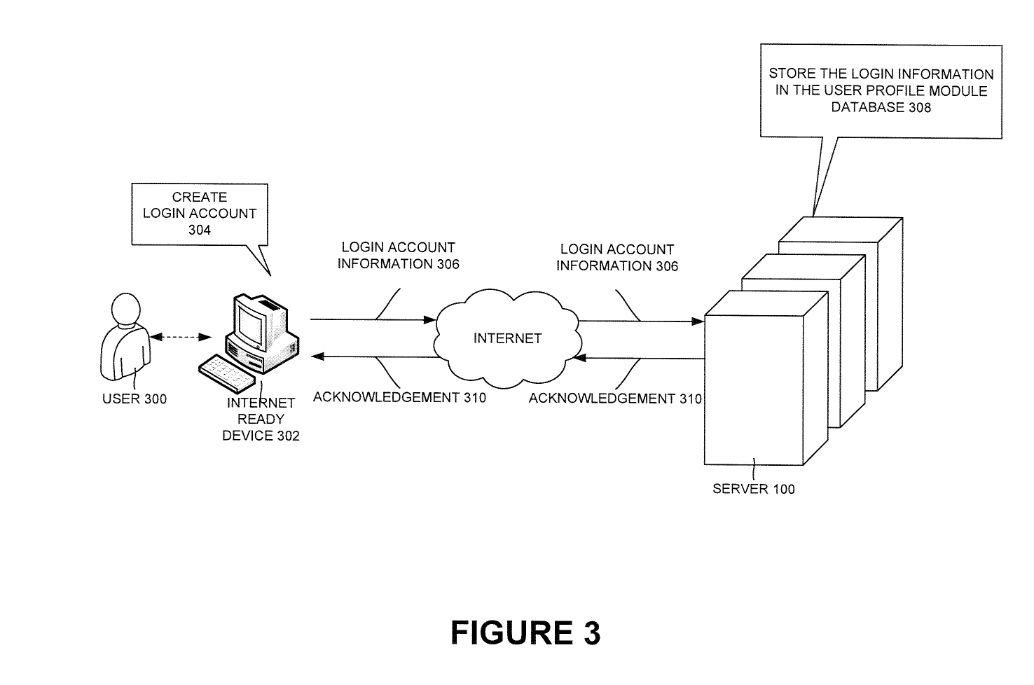

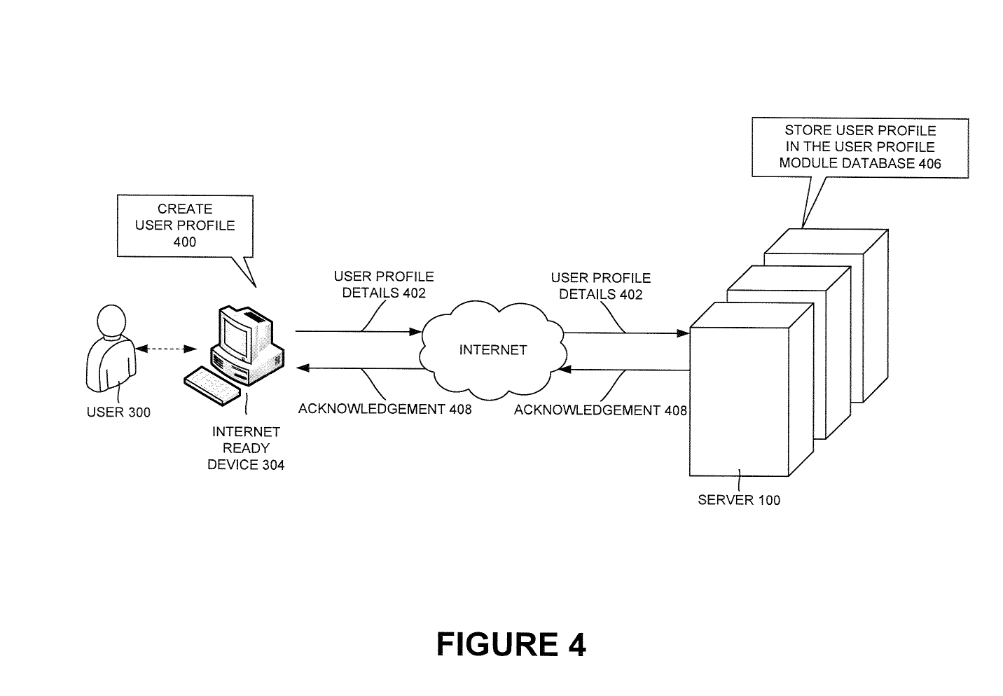

FIGS. 3 and 4 show the method through which Users 300 may register with, and create an account in, User Profile Module Database 102. A User 300 may access the Server 100 and User Profile Module Database 102 via a website linked to the server and databases using any Internet-ready device 302. Users 300 may include selling users, purchasing users, users who sell and purchase products and services, corporations or businesses, agents for corporations or businesses, retail stores, manufacturers, distributors, service providers, wholesalers, or any individual who wishes to buy or sell items through the system. Users 300 may access the system via the World Wide Web and create an account 304 with in the User Profile Module Database 102 using any Internet-ready device, including but not limited to, desktop computers, laptop computers, tablet computers, netbooks, cellular or smart phones, or other Internet capable PDAs or other handheld electronic devices.

When registering with the Server 100, the User 300 may be prompted to create and provide login information 304 to the Server 100 for registration with the User Profile Module Database 102. Login information may include an email address, a user name, a password, or any other indicia that allows the system to recognize the User 300 when the User 300 attempts to access the Marketable Inventory Module Database 108. Once the User 300 has submitted its login information 306, the information will be stored 308 in User Profile Module Database 102, and a confirmation 310 that the User 300 is registered will be provided. Acknowledgement may be, for example, in the form of a pop-up window from the website, a page on the website, an email, a text or SMS message and as should be appreciated by those having skill in the art, when acknowledging the creation of the account 310, the system may provide further instructions for steps that must be taken for activating the newly created account. For example, an acknowledgment from a pop-up window or page on the website may notify the User 300 that an email has been sent to the User 300's email account containing a link that must be followed by the User 300 in order to complete registration and activate the User 300's new account.

Regardless of whether any activation is required, when registering with the system or anytime thereafter, User 300 may enter data for user profile 400 containing additional information about the User 300 that will be stored in the User Profile Module Database 102. Once the User 300 has entered all profile data 400 that the User 300 wishes to provide to the system, the profile information will be transmitted 402 to and stored 406 in the Server 100. Upon receipt of the profile information, the system will provide an acknowledgment 408 that the profile information has been received and stored in the User Profile Module Database 102.

Providing information to the User Profile Module Database 102 will facilitate communication between the User 300 and the system and the User 300 and other users, and enhance the User 300's experience with the system. Information that may be provided to and stored in the User Profile Module Database 102 may include: social medial contact information, like for example Facebook information, Twitter contact information, My Space information, LinkedIn information or other social network websites; mailing or billing addresses; contact phone numbers; payment information such as credit or debit card information or bank account information; and/or, additional email contact information.

In order to insure the User 300 is notified of products or services it may be interested in, each user may provide information through surveys or questionnaires indicating products or services the User 300 may be interested in purchasing or typically purchases. Inputting such information may allow the system to provide periodic custom messages to the user regarding purchasable items currently listed in the Market Inventory Module Database 108. Providing such information also benefits selling users who seek to notify potential interested purchasing users that the selling user has listed a particular product or service. The more information each User 300 provides to the User Profile Module Database 102, the more information each User may be provided with regarding purchasable items listed for sale in the Market Inventory Module Database 108. As should be appreciated by those having skill in the art, each User 300 may also provide information related to the category or products the User 300 typically sells. Providing such information may facilitate requests for purchases by users and allows the User 300 to obtain business and notify other users or its products or services.

In order to prevent unsolicited contacts related to the listing of products or services for sale, a User 300 may configure settings in its profile limiting the information about purchasable items to only those meeting certain criteria. For example, a User 300 may restrict contact to only those selling users the User 300 has purchased products or services from, a customized list of approved selling users, or no selling users at all. A User 300 may also be able to enable a setting in the User 300's profile to have the system provide a list of recommended products or services currently being offered each time the User 300 logs into the system.

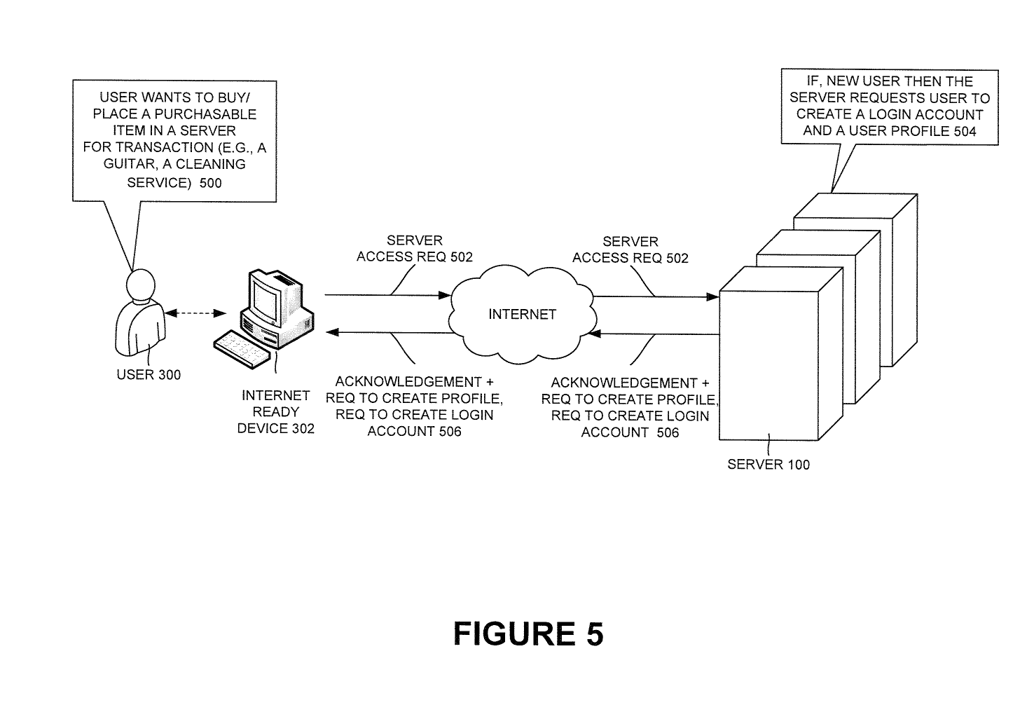

As shown in FIG. 5, as an alternative method of registration, a User 300 may be prompted to register with the User Profile Module Database 102 and create a profile the first time the User 300 attempts to utilize the system to complete a transaction. If a User 300 who is not yet registered with the User Profile Module Database 102 wants to offer a product or service for sale, or purchase product or service listed in the Market Inventory Module Database 108 (collectively step 500), the User 300 may request to list or purchase the purchasable item or service 502, at which time the User Profile Module Database 102 will check for a user name and login 504, and if none is received, provide with an acknowledgment of the request and require the new User 300 to register 506 with the User Profile Module Database 102. Once the User 300 provides the necessary registration information, the User 300 may be allowed to proceed with the transaction.

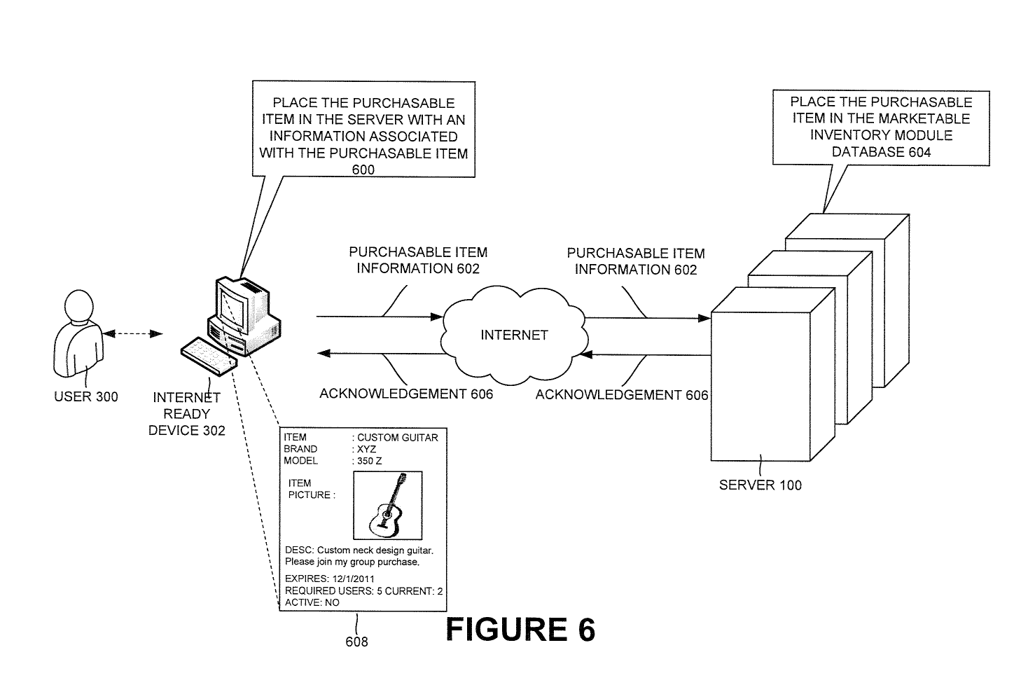

When a user 300 creates a group to sell a product or service (or multiple users create a group or groups to sell multiple products or services together), the User 300 functions as a selling user and may provide data regarding the product and/or service and set parameters that must be met before the product or service becomes active. Once the product or service becomes active, the purchasable item must be provided to any Users 300 in the group, i.e. the purchase group or the purchasing users. As seen in FIG. 6, the selling user 300 may utilize any Internet-ready device 302 to enter information 600 regarding a purchasable item the selling user wishes to place in the Market Inventory Module Database 108 for sale. When placing the purchasable item for sale in the Market Inventory Module Database, in addition to any of the information shown in FIG. 2, the selling user may input information, such as the name of the purchasable item, a category for listing the purchasable item, the manufacturer or creator of the product or providers of the service if different from the selling user, the model of the product, any products used in the service, a picture of the product or related to the service, and a detailed description of the purchasable item. When listing the purchasable item, a selling user may offer a new, previously unavailable product or service, or alternatively may offer an existing product or service at a discount to the group of purchasing users. As the number of purchasing users in the purchase group grows, the selling user may offer further discounts on the listed purchasable item.

The selling user may also set one or more parameters purchase group must reach before the purchasable item becomes active and must be provided to the purchasing users. For example, when listing the purchasable item for sale, the selling user may set a minimum total number of sales of the purchasable item and/or a minimum number of purchasing users required to join the group before the purchasable item becomes active. The selling user may alternatively, or additionally, set a total amount of aggregate money paid by the purchase group before the product or service becomes active or a further discount is recognized. The selling user may also set parameters for the locale of where a product or service will be provided to purchasing users, or that only purchasing users who have previously purchased a product or service from the selling user may join the group. A selling user may also input a time limit or date by which any purchasing users must join the group in order to purchase the product or service, or by which any other parameters required by the selling user must be met. Once the purchase group meets any parameters set by the selling user, the purchasable item will become active and the selling user will be required to provide the purchasable item to all purchasing members. Once the selling member has entered all the information related to the product or service being offered and any parameters the selling user requires before the product or service will become active 602, the Measurement Module Database 106 and Market Inventory Module Database 108 will store the information 604 and track all users who join the group.

Once the selling user has listed the product, provided all the details and description the selling user wants to provide and set any parameters the selling user requires before sale 602, a return acknowledgment 606 will be received from the Market Inventory Module Database 108 by the selling user, and the selling user may utilize various methods within the Server 100 and User Profile Module Database 102 to notify potential purchasing users that a particular product or service has been listed. The acknowledgment may contain an example of how the listing may be viewed 608 by other users to the selling user listing the product. This acknowledgment may also contain or be accompanied by a link or option to notify other users that the purchasable item has been listed in the system through social media contacts stored within the selling user's profile, or by prompting the Server 100 to provide a message to any users who have indicated an interest in purchasing similar products or services. The Server 100 may provide a message to the potential purchasing users through social media information loaded and stored in the User Profile Module Database 102, through email, through text or SMS messaging, or any time a user who has indicated interest in the type of purchasable item listed logs into the Server 100 while the product or service is listed in the Market Inventory Module Database 108.

The selling user may alternatively provide information to various potential purchasing users through its own social media contacts or social media pages, or email. When notifying the potential purchasers through its own contacts, the selling user may provide a link directly to the product with information about registering with the Server 100 for any potential purchasers who are not registered with the Server.

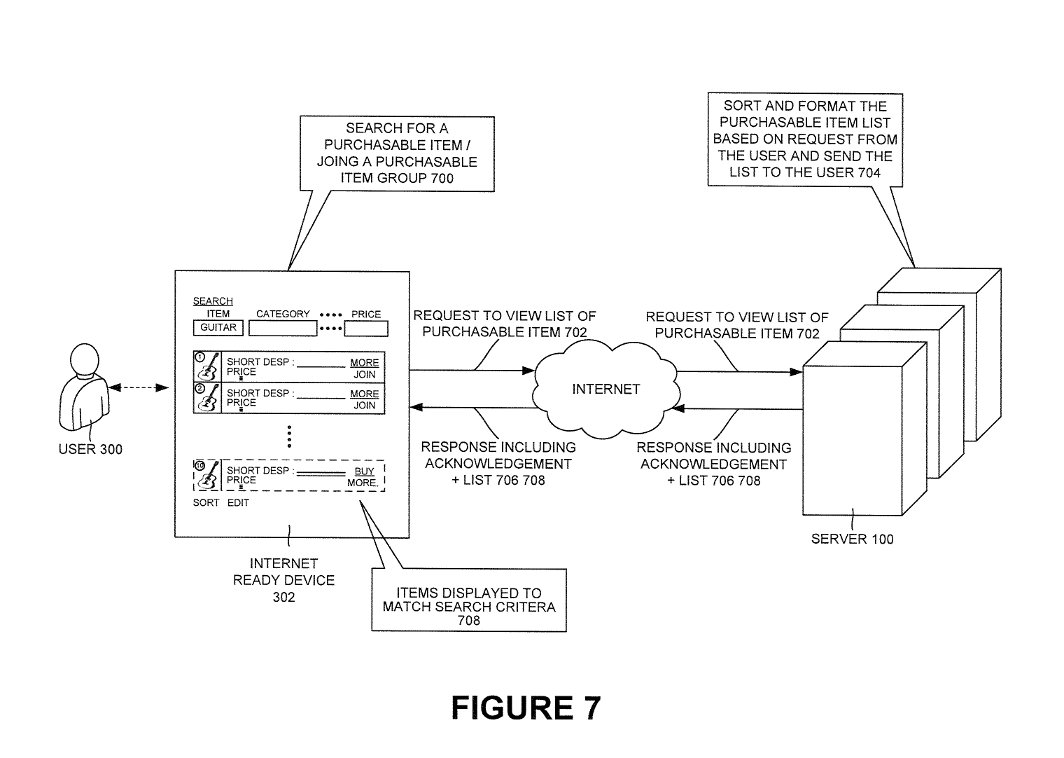

Alternatively, as seen in FIG. 7, purchasing users may be able to search the Market Inventory Module Database 108 for listed products or services and join already existing purchase groups to purchase the same. The purchasing user may access the website via its Internet-ready device and use a searching interface contained within the Market Inventory Module Database 108 and/or Measurement Module Database 106 to enter search parameters to find a purchasable item. The User 300 may search 700 the Market Inventory Module Database 108 by: product or service, product or service category, location of the product or service, activation status, price, date the product or service was listed, date or time limit the product or service must be activated by, by selling user, whether the item was offered for sale or requested for purchase, or any other parameters entered by a selling user into the Market Inventory Module Database 108. After a purchasing user submits its search criteria 702, the Market Inventory Module Database 108 will sort through all existing listings 704. Once the Market Inventory Module Database 108 and the Measurement Module Database 106 have completed a review of all listed purchasable items, the system will provide a response acknowledging 706 the request, and a list 708 with all products or services matching the criteria entered by the purchasing user.

The list 708 returned to the purchasing user as a result of a search 702 may provide limited information to the User 300 regarding each matching product or service that matches the search criteria. Each item included on the list 708 however, may be interactive to allow the user to join the group to purchase the product or service, or link to additional information regarding each product or service. If the User 300 follows a link to find out more details about the product or service, the specific listing may further include links to join the purchase group and to provide social media contact information, email addresses, phone numbers or the like for the User 300 to notify other potential purchasing users that the product or service is available for purchase in the system.

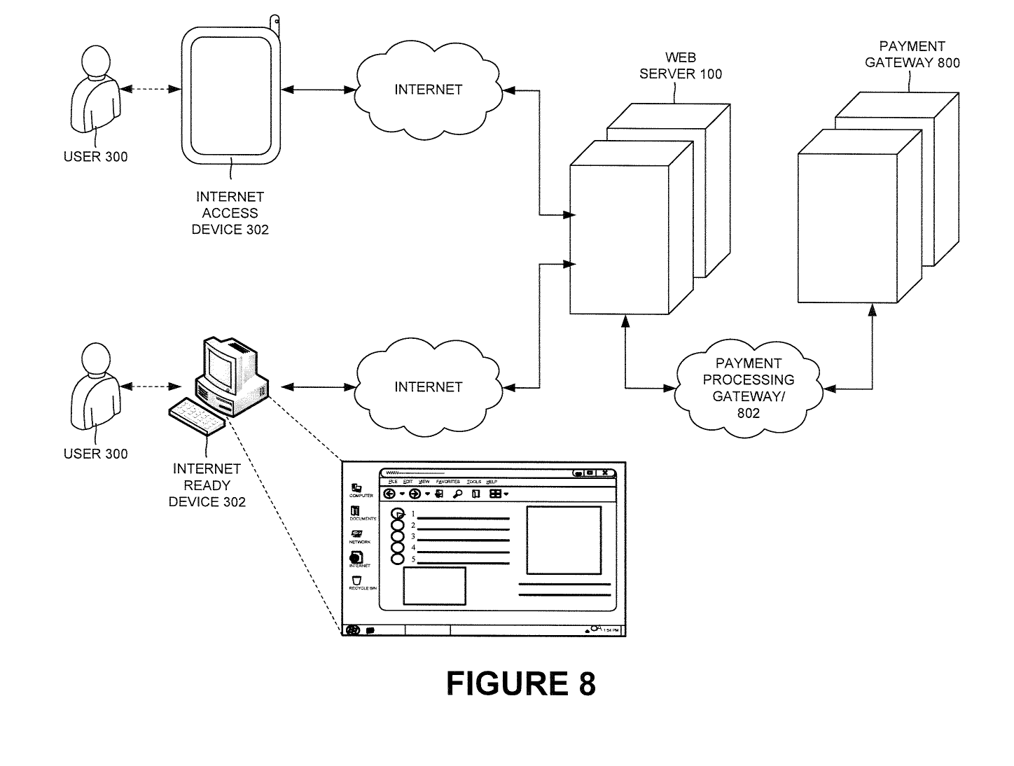

At the time a purchasing user joins an existing purchase group, the purchasing user may be required to provide necessary payment information. Any User 300 who includes payment information as part of its user profile may be provided with a quick link for payment, while those who do not may be asked to provide a method of payment in order to secure the purchase of the product or service. As seen in FIG. 8, the Server 100 may access a Payment Gateway 800 via a payment processing 802 for Users 300 to provide payment.

In a preferred embodiment, in order to insure that payment is collected immediately while guaranteeing refunds for any products or services that do not become active because a group parameter is not been met, a seller chooses to cancel the product or service offer, or the purchaser decides to leave the group, the payment may be held in an escrow account linked to the Payment Gateway 800. Alternatively, Payment Gateway 800 may be configured so as to place a hold on an account linked to the User 300's method of payment. For example, if a User 300 decides to use a credit or debit card to purchase the product or service, a hold for the amount of the product or service may be placed on the User 300's credit or debit card account until the product is either cancelled, the purchaser leaves the purchase group, or the purchasable item becomes activate.

As should be appreciated by those having skill in the art, the system and Payment Gateway 800 may be configured to track any payments made by purchasing users for products that have not yet become active. If the product is not activated, Payment Gateway 800 may release the hold on User's 300 method or payment or refund any money already paid to the system by User 300. Tracking also allows Payment Gateway 800 to provide partial refunds or release a portion of a hold on User's 300 method of payment should a selling user choose to lower the price of the item offered to the group, or if a further discount is achieved through additional purchasing users joining the group and meeting a selling user's parameter(s) for further discount.

Once each group parameter has been met, the funds held in the escrow account or any funds being held on a purchasing user's account may be released and the selling user will receive payment in full from the system and/or Payment Gateway 800. Once the funds have been received, the selling user will then be required to provide the product or service to each purchasing user.

Once all payments have been released, each purchasing user may be prompted to leave feedback with the server regarding the selling user and the product or service. Feedback requests may be transmitted by the Server 100 in the same manner that any messages regarding products or services that have been listed may be transmitted to each purchasing user, like, for example, through social media websites, email, text or SMS messaging, or when the next time the purchasing user logs into the Server 100.

In addition to a selling user listing a product for sale, a purchasing user may also request a product or service for purchase from any users registered with the service in essentially the same manner as a selling user would list a product or service for sale. In order to request a product or service, following FIG. 6, a purchasing user would use its Internet-ready device to enter various parameters regarding the product or service the user seeks 600. Information which may be entered into the Market Inventory Module Database 108 may include, a type of product, a product manufacturer, the date the product or service must be provided to the purchasing user, a detailed description of the product or service the purchasing user is looking for, a first purchase price at which the requesting purchasing user is interested in purchasing the product or service, and, the number of purchasing users interested in the product or service. Once the purchasing user finishes entering all the parameters for the requested product or service 602, the Market Inventory Module Database 108 will store the information 604, and provide confirmation to the user that the product or service request has been listed 606. As with the listing of a purchasable item for sale, the User 300 may be provided with an option to contact other users who may be interested in joining the purchase group for the same purchasable item, as well as, an option to contact users who typically sell such products or provide such services. If a selling user receives a request and provides the product or service, the selling user may respond to the purchasing user directly or through the system via any of the methods discussed herein, including but not limited to, email, through social media websites, via SMS or text messaging, or through a message delivered to the purchasing user the next time the purchasing user logs into the Server 100. Alternatively, the selling user may choose to outright join the group and offer the product or service requested by the user.

A purchasing user may likewise use any of the contact methods discussed herein to attempt to contact multiple selling users to attempt to find a selling user who is willing to provide the requested product or service. Once contacted, the selling user can choose to fill the request, or, in the alternative provide a counter-offer, at for example a different price than the one requested by the purchasing user, by joining the group and setting a new price or new group parameters, like for example a minimum number of purchasers or minimum aggregate amount of dollars sold. Alternatively, the selling user may choose to create a new purchase group offering the product or service at its own price or parameters and notify the requesting purchasing user that the group for the product or service has been created. Additional purchasing users who may also be interested in the requested product or service may also be contacted by the requesting purchasing user in order to increase the size of the purchasing group in an attempt to further entice a selling user to provide the product or service. Regardless of whether a User 300 is contacted by the requesting purchasing user or not, any User 300 may choose to join to any existing requested product or service listing and either also request, or offer to provide, the product or service.

Rather than join the purchase group established by a purchasing user requesting the product or service, a selling user may choose to offer the requested product or service at a different price with any parameters for sale discussed herein. The selling user may do so by entering the product or service through its Internet ready device 600 with all information entered transmitted to 602, and stored in 604, the Market Inventory Module Database 108 in the same manner as listing any other product or service. Once the product has been listed, the selling user, through any of the contact methods discussed herein, may notify any members in the existing requesting group that the product or service has been listed. The purchasing users then will have the option of joining the new purchase group listed by the selling user at the price and parameters set by the selling user. In the alternative, the requesting purchasing user may instead have the option of continuing to list the request in the hopes that for another user will provide the requested product or service at the requesting purchasing user's price and parameters.

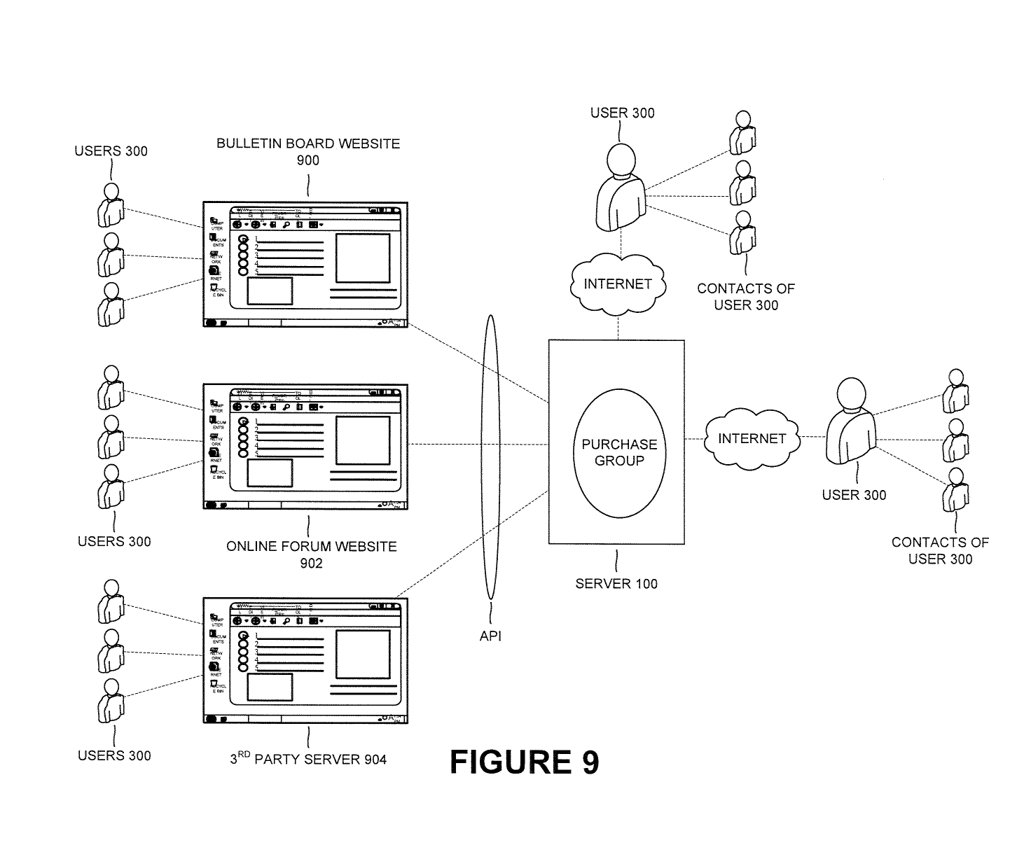

FIG. 9 shows an embodiment of the system utilizing the plug-in for Application Programming Interface (API) Module 121. As seen in FIG. 9, plugging-in and utilizing the API Module 121 allows users 300 to access the service and server 100 from multiple websites, like for example, bulletin board website 900, online forum website 902, 3rd party server 904. As users log onto each of the websites 900, 902, and/or 904, link to server 100 may be provided which allows users 300 to join existing purchase and/or requesting groups. In embodiments where API Module 121 provides a link and allows users from outside websites 900, 902, and/or 904 to join requesting or purchasing groups, users 300 may still log into the system as described above and create and/or join existing purchasing groups and provide other user contacts, either directly or indirectly, to entice additional users to join an existing group. Utilizing API Module 121 enables more consumers to be reached, creating larger groups and enhancing the possibility of any group parameters set by a seller to be reached.

It is to be understood that the present invention may be embodied in other specific forms without departing from the spirit or central characteristics thereof. That is, any type of Internet-ready device, server, or contact method known to one of ordinary skill in the art may be utilized to accomplish the objects described herein. The present embodiments, therefore, are to be considered in all respects as illustrative and not restrictive, and the present invention is not to be limited to the details provided herein. Thus, while specific embodiments have been illustrated and described, numerous modification come to mind without significantly departing from the characteristics of the present invention and the scope of protection is only limited by the scope of the accompanying claims.

1. A method for selling or purchasing a product or service, the method comprising the steps of:
providing and connecting a server to the Internet;
creating one or more databases on the server;
registering one or more users with the one or more databases;
storing, gathering, and organizing user information and products or services requested or listed for sale by the one or more registered users in the one or more databases; and,
creating one or more purchase groups in the one or more databases wherein at least one of the one or more registered users offer at least one product or service for sale or request at least one product or service for purchase.

2. The method of claim 1 further comprising the step of creating a user profile for each registered user.

3. The method of claim 2 further comprising the step of receiving user input when registering from the one or more registered users regarding at least one of:
types of products or services the one or more registered users may be interested in purchasing; and,
types of products or services the one or more registered users may offer for sale.

4. The method of claim 2 further comprising the step of configuring settings in each user profile to limit contact from other registered users.

5. The method of claim 2 further comprising the step of configuring setting in each user profile to provide notifications to each registered user regarding products or services listed for sale.

6. The method of claim 1 further comprising the step of obtaining contact information for each registered user.

7. The method of claim 6 further comprising the step of obtaining the social media contact information of the one or more registered users during registration.

8. The method of claim 1 further comprising the step of notifying the one or more additional registered users that the group has been created to sell or purchase the at least one product or service.

9. The method of claim 8 further comprising the step of utilizing social media websites to notify the one or more additional registered users that the at least one product or service has been listed for sale or requested for purchase.

10. The method of claim 1 further comprising the step of setting one or more group parameters which must be achieved before the at least one product or service becomes activated.

11. The method of claim 10 wherein the one or more selling registered users set the group parameters.

12. The method of claim 10 further comprising the step of requiring the one or more selling registered users to sell the at least one product or provide the at least one service to the one or more purchasing registered users when one or more defined group parameters are reached.

13. The method of claim 10 wherein the one or more group parameters include a total number of sales of the at least one product or service.

14. The method of claim 10 wherein the one or more group parameters include a total aggregate monetary amount sold for the at least one product or service.

15. The method of claim 10 wherein the one or more group parameters include a date by which all group parameters must be reached before the product or service becomes active.

16. The method of claim 10 wherein the one or more group parameters include a time limit on the date by which all group parameters must be reached before the product or service becomes active.

17. The method of claim 10 wherein the one or more group parameters include a restriction on the location of where the product or service will be provided.

18. The method of claim 10 wherein the one or more group parameters include requirement that all purchasing users be former customers of the selling user.

19. The method of claim 10 wherein the one or more group parameters include a discount that all purchasing users are entitled to as a group.

20. The method of claim 1 further comprising the step of requiring a payment of funds for the at least one product or service from the one or more purchasing registered users when the one or more purchasing registered users join the group.

21. The method of claim 20 further comprising the step of placing an account hold for the amount of the payment required from the purchasing user at the time the purchasing registered user joins the group.

22. The method of claim 21 further comprising the step of releasing the account hold if the product or service does not become active.

23. The method of claim 21 further comprising the step of providing the funds to the selling user when the product or service becomes active.

24. The method of claim 20 further comprising the step of holding the funds in an escrow account for the one or more selling registered users.

25. The method of claim 24 further comprising the step of releasing the funds in the escrow account to the one or more selling registered users when the one or more group parameters are reached.

26. The method of claim 24 further comprising the step of returning any funds paid by the one or more purchasing registered users if the product or service does not become active.

27. The method of claim 1 wherein the offer for sale is a discount on an existing product or service.

28. The method of claim 1 wherein the at least one product or service is a product or service not previously offered by one or more selling registered users creating the group.

29. The method of claim 1 further comprising the step of offering the requested at least one product or service at a different purchase price when one or more selling registered uses join the purchase group.

30. The method of claim 1 further comprising the step of providing feedback to the server once a transaction to purchase a product or service is completed.

31. The method of claim 30 further comprising the step of storing feedback received for each registered user.

32. The method of claim 31 further comprising the step of the server providing a rating for each registered user offering a product or service for sale.

33. The method of claim 1 further comprising the step of linking the purchase groups to third party websites through an application programming interface.

34. A system for selling and requesting products or services, the system comprising:
a server connected to the world wide web;
at least one database on the server for registering and storing users who list, purchase or request products or services for purchase;
at least one database on the server for listing products or services for sale or to request products or services for purchase wherein the server is configured to:
list and track groups of users interested in purchasing the same product or service;
allow additional users to join existing groups and purchase the same products or service;
allow users to set parameters which must be met before the product or service will be sold or purchased.
